(19) United States
(12) Patent Application Publication
(10) Pub. No.: US 2013/0269238 A1
(43) Pub. Date: Oct. 17, 2013

(54) Electronic Insect Barrier

(71) Applicant: Richard K. Bronk, Shenandoah, PA (US)

(72) Inventor: Richard K. Bronk, Shenandoah, PA (US)

(21) Appl. No.: 13/884,955

(22) PCT Filed: Nov. 14, 2011
(86) PCT No.: PCT/US2011/060530

§ 371 Date: May 11, 2013

Related U.S. Application Data
(60) Provisional application No. 61/413,118, filed on Nov. 12, 2010.

(51) Int. Cl. A01M 1/22

(52) U.S. Cl. CPC A01M 1/223
USPC 43/112; 43/123

(57) ABSTRACT

A electronic insect barrier is provided that includes individual units, powered by electrical current supplied through power cords or network connections to power electronic circuits contained in housings, shielded by circuit board covers, units having a base with a bed leg anchor, supporting and stabilizing a bed leg away from electrical conductors separated by insulators, a means for killing insects particularly bedbugs who enter the housing through crawl holes and an opening, said bugs coming in contact with conductors as they egress a bed.

This application claims the benefit of U.S. Provisional Application No. 61/413,118 filed Nov. 12, 2010, which is hereby incorporated herein by reference.

### BACKGROUND OF THE INVENTION

The present application relates to devices for creating insect barriers and more particularly for creating a bed bug barrier between the floor and the bed.

Reports of bedbug infestations continue to rise since about 1995 and numerous systems have been used to rid a home of an infestation. The most common type of bedbug is Cimex lectularius. The term usually refers to species that prefer to feed on human blood. All insects in this family live by feeding exclusively on the blood of warm-blooded animals Bed bugs, though not strictly nocturnal, are mainly active at night and are capable of feeding unnoticed on their hosts.

Pesticides that have historically been found to be effective include: pyrethroids, dichlorvos and malathion. Resistance to pesticides has increased significantly over time and there are concerns of negative health effects from their use. More recently, in the United States, the Environmental Protection Agency (EPA) has become involved in indoor use of chemicals, reducing, limiting and in some instances banning there use because of potential toxicity to children after chronic exposure to some chemicals.

Mechanical approaches such as traps, coasters, vacuuming up the insects and heat treating or wrapping mattresses have been recommended to keep bedbugs from entering the bed. The problem with these mechanical systems, however, is that they are not entirely effective.

As such, there is a need for a device that prevents bed bugs from crawling from the floor to the bed leg and onto the mattress by using electricity to destroy the bed bugs or otherwise.

### SUMMARY OF THE INVENTION

In at least one embodiment, an insect barrier device is provided that includes: a base; a housing coupled to the base; and a stack of a plurality of planer conductors located within the barrier device between the base and the housing. The housing and the each of the plurality of planer conductors have an inner hole therein aligned for a leg of an item of furniture to pass there through onto the base.

In at least one embodiment, the planer conductors are essentially horizontal when in use.

In at least one embodiment, the housing creates at least one hole between the housing and the base for insects to enter the device.

In at least one embodiment, the planer conductors are located within the device such that insects entering the at least one hole between the housing and the device must walk across at least one side of the stack with exposed ends of the plurality of planer conductors to progress toward the leg of the item of furniture.

In at least one embodiment, the device comprises a power unit that creates an electrical potential between pairs of conductors.

In at least one embodiment, the power unit creates sufficient potential for a spark to travel through the bug without the bug having to touch both of a pair of conductors.

In at least one embodiment, the base comprises a tubular anchor that separates the leg of the item of furniture from the plurality of planer conductors.

In at least one embodiment, the base and the housing are removable coupled to each other with at least a pair of columns

In at least one embodiment, the columns pass through and locate each of the plurality of planer conductors within the housing.

In at least one embodiment, the device includes at least one spacer located between pairs of the planer conductors.

In at least one embodiment, an insect barrier system is provided that includes a plurality electrically coupled individual units, each of the plurality of units including: a base; a housing coupled to the base; and a stack of a plurality of planer conductors located within the barrier device between the base and the housing. The housing and the each of the plurality of planer conductors have an inner hole therein aligned for a leg of an item of furniture to pass there through onto the base.

In at least one embodiment, the planer conductors are essentially horizontal when in use.

In at least one embodiment, the housing creates at least one hole between the housing and the base for insects to enter the device.

In at least one embodiment, the planer conductors are located within the units such that insects entering the at least one hole between the housing and the units must walk across at least one side of the stack with exposed ends of the plurality of planer conductors to progress toward the leg of the item of furniture.

In at least one embodiment, the units comprise a power unit that creates an electrical potential between pairs of conductors.

In at least one embodiment, the power unit creates sufficient potential for a spark to travel through the bug without the bug having to touch both of a pair of conductors.

In at least one embodiment, the base comprises a tubular anchor that separates the leg of the item of furniture from the plurality of planer conductors.

In at least one embodiment, the base and the housing are removable coupled to each other with at least a pair of columns.

In at least one embodiment, the columns pass through and locate each of the plurality of planer conductors within the housing.

In at least one embodiment, the units include at least one spacer located between pairs of the planer conductors.

Additional aspects of the present invention will be apparent in view of the description which follows.

### BRIEF DESCRIPTION OF THE FIGURES

FIG. 1 is a perspective view of a device for preventing bed bugs from crawling from the floor to the bed according to one embodiment.

FIG. 2 is a perspective view of a device for preventing bed bugs from crawling from the floor to the bed according to one embodiment.

FIG. 3 is a perspective view of a device for preventing bed bugs from crawling from the floor to the bed according to one embodiment.

FIG. 4 is a cross section view taken from FIG. 3 of a device for preventing bed bugs from crawling from the floor to the bed according to one embodiment.

FIGS. 5 and 5A-5D show a schematic diagram of the device electronic circuit.

FIG. 6 is a top view of one embodiment of a device conductor.

FIG. 7 is a top view of one embodiment of a device insulator.

FIG. 8 is a perspective view of a device for preventing bed bugs from crawling from the floor to the bed according to one embodiment.

FIG. 9 is a cross section view taken from FIG. 8 of a device for preventing bed bugs from crawling from the floor to the bed according to one embodiment.

### DETAILED DESCRIPTION OF THE INVENTION

The device of the present application is designed to kill crawling insects 30 more specifically it targets bed bugs 30. That is, the electronic insect barrier 10 is designed to surround a bed leg 14 and intersects the path bedbugs 30 most typically take to egress a bed. In their path of travel, the insects 30 or bed bugs 30 enter an individual unit 12 through the crawl holes 36 or opening 32 and crawl over electrified metallic conductors 18 that kill them on contact. Alternatively, crawl holes 36 may be a continuous opening around the perimeter of the individual units 12. In this instance, the opening 36 may be continuous to give insects 30 less access to crawl up housing 16 toward opening 32. The device uses a power source such as alternating or direct current, AC and/or DC, and an electronic circuit 24 as an electrocution means. In one embodiment the electronic insect barrier 10 has an input voltage of 12 volts DC and an output voltage of 2,400 volts DC to kill insects 30 and more specifically bedbugs 30.

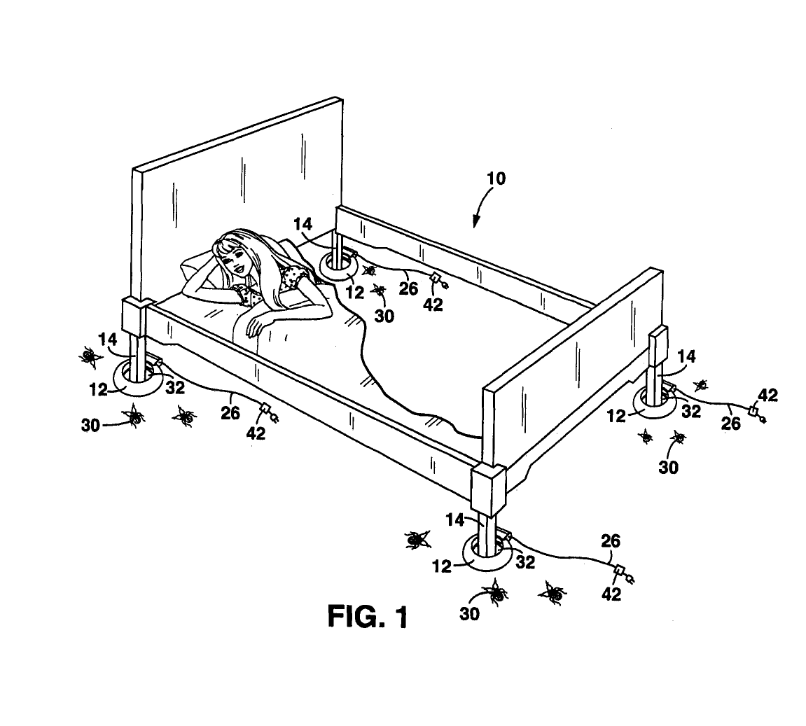

Referring to FIG. 1 the electronic insect barrier 10 consists of individual units 12 used to surround each of the typically four bed legs 14. More units 12 may be used to accommodate beds that have five, six, or more bed legs 14. Each unit has a housing 16 or container that surrounds/creates a barrier around the bed leg 14. The housing 16 may be made of any material, but is preferably made from plastic, it is about 1 to 4 inches tall, is circular in shape, and the diameter is about 4 to 10 inches. The housing 16 is preferably made of one or more components, to shelter the conductors 18 for safety, to prevent bedding material from falling into the device, and to prevent people and pets from making contact with the conductors 18. This housing 16 has an about 2-8 inch diameter opening 32 with circular shape to accommodate the bed leg 14.

The housing 16 further includes a base 22 that will receive the weight of the bed leg 14, passing through the housing 16. The bed leg 14 is bounded by the bed leg anchor 34, attached to base 22. The purpose of the bed leg anchor 34 is to prevent the bed leg 14 from coming into contact with conductors 18. Another purpose of the bed leg anchor 34 is to assist in maintaining a distance of no less than one inch between the bed leg 14 and the perimeter of opening 32, inhibiting the jumping of bedbugs 30 from the housing 16 to the bed leg 14. The housing 16 and the base 22 may be connected with an arced or tubular housing 16 wall, as shown in the drawings. The housing 16 may be removably coupled to the base 22, for example, for cleaning. The housing 16 may alternatively or additionally be connected to the base 22 with a plurality of columns The columns may be located within the perimeter of the conductors 18. In this respect, bugs entering the crawl hole or holes 36 cannot climb up the columns without first being exposed to the conductors 18. The columns may also serve to locate the conductors 18 within the housing 16.

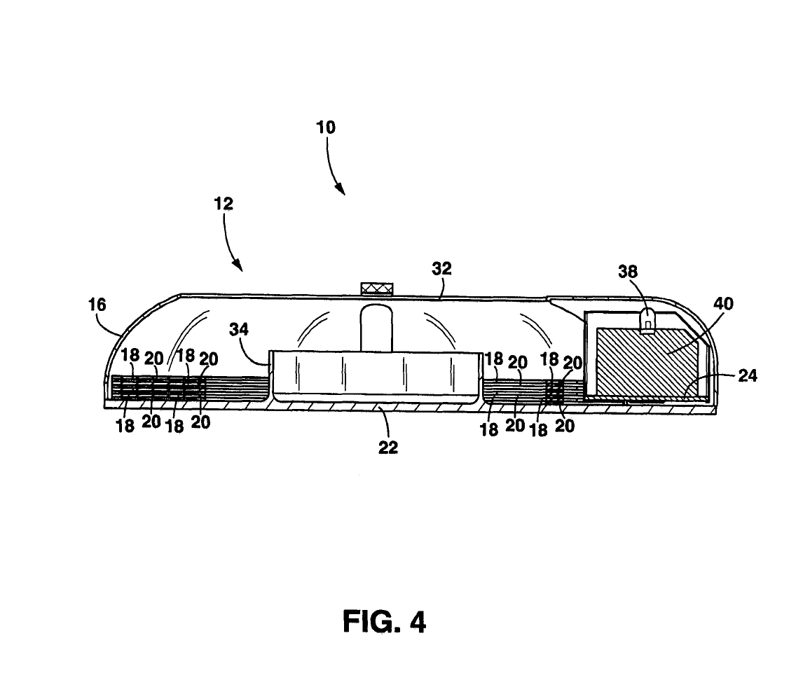

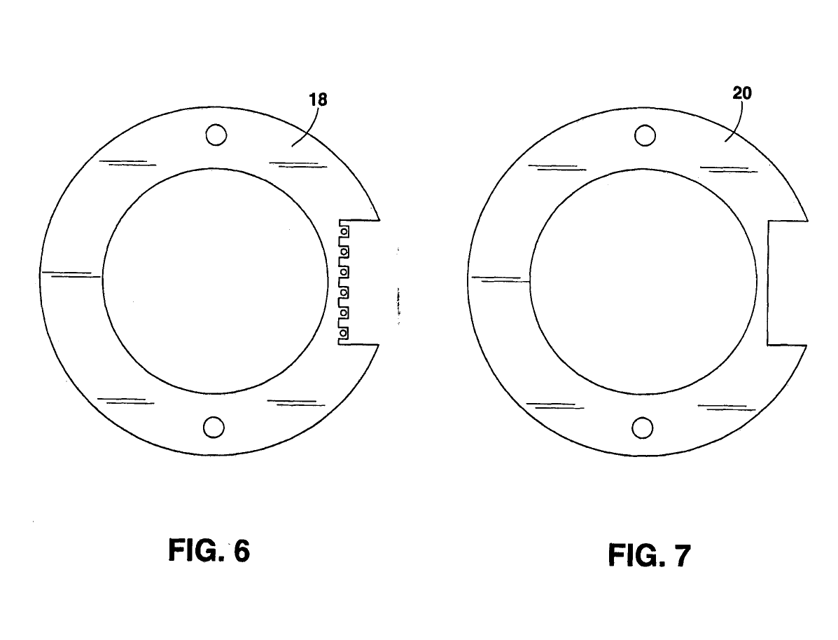

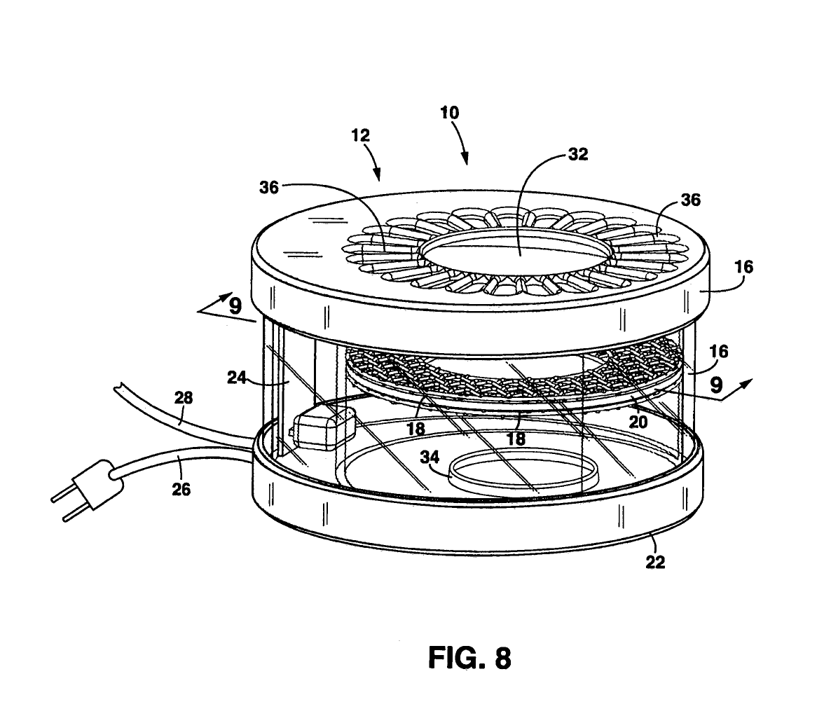

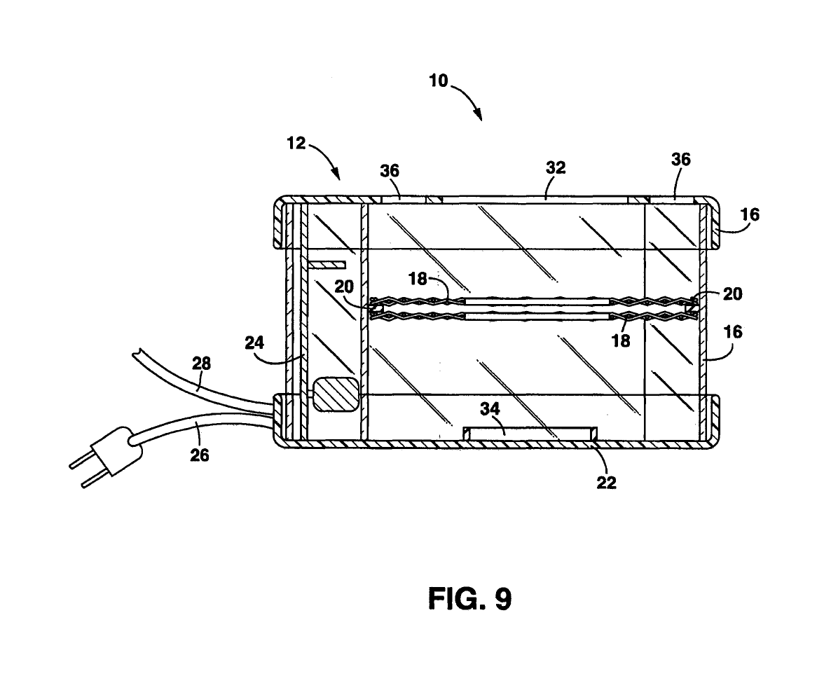

Within the housing 16 is one or more electrified metal conductors 18 that are about 4 to 8 inches across, have a 2 to 5 inch hole in the middle to accommodate the bed leg 14 and the leg anchor 34. The electrified metal conductors 18 are comprised of an upper electrified metal conductor 18 and a lower electrified metal conductor 18 that are electronically insulated/spaced away from each other by one or more insulators 20. The conductors 18 and/or insulators 20 maybe planer structures, as shown in FIGS. 6 and 7, stacked over each other, as shown in FIG. 4. Pairs of conductors 18 preferably have opposite polarities. The voltage potential between a pair of conductors is preferably such that a bug walking across the surface created with the stack of the conductors will cause a current to travel through the bug. Both the upper and lower conductors 18 have holes through the center of them. The holes in both conductors 18 are of sufficient size to allow a bed leg 14 to pass through the holes. Both the upper and lower conductors 18 are secured within the housing 16, surrounded by the housing 16 perimeters.

The conductors 18 may have variable diameters/sizes to create a meandering pattern that bugs must traverse to make it through the individual unit 12 before reaching the bed leg 14. For example, the edges of the conductors 18 and insulators 20 could create an inclined ramp or stairs for the insects 30 to crawl, as opposed to the vertical wall shown in FIG. 4. This would be accomplished by differences of diameter of the conductors 18 and insulators 20. The shape of the perimeter of the housing 16, metal conductors 18 and insulators 20 may be circular, square, elliptical or rectangular or many other shapes, and the size of the conductors 18 may vary considerably. In any event, the units 12 create a 360 degree barrier around the bed leg so that bugs attempting to reach the leg 14 will be subject to electrocution. The conductors 18 may be solid plates or be formed from interwoven conductors 18.

The electrical components inside each unit are typical electrical components that are used in many other electronic devices. The electrical components in the preferred embodiment of the electronic insect barrier 10 and individual units 12 are designed to accept a low voltage input and then increase the voltage to a very high voltage that is sufficient to kill an insect 30 or bed bug 30 when it walks on or makes contact with the electrified metal conductors 18. In alternate embodiments of the device, the power may be supplied to the electrified metal conductors 18 directly from a high voltage source and without the need for voltage amplification.

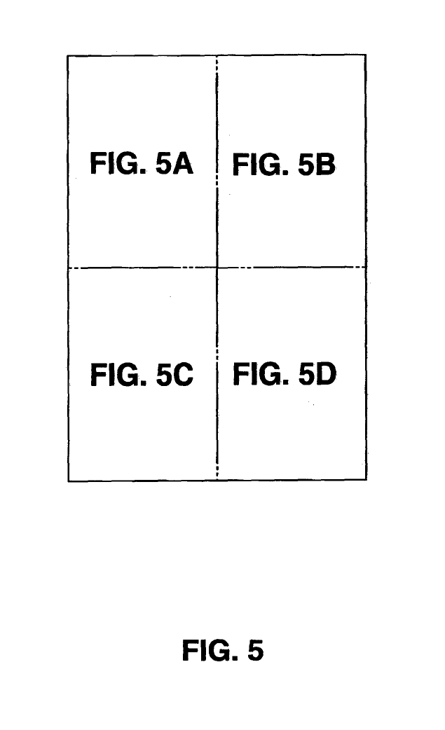

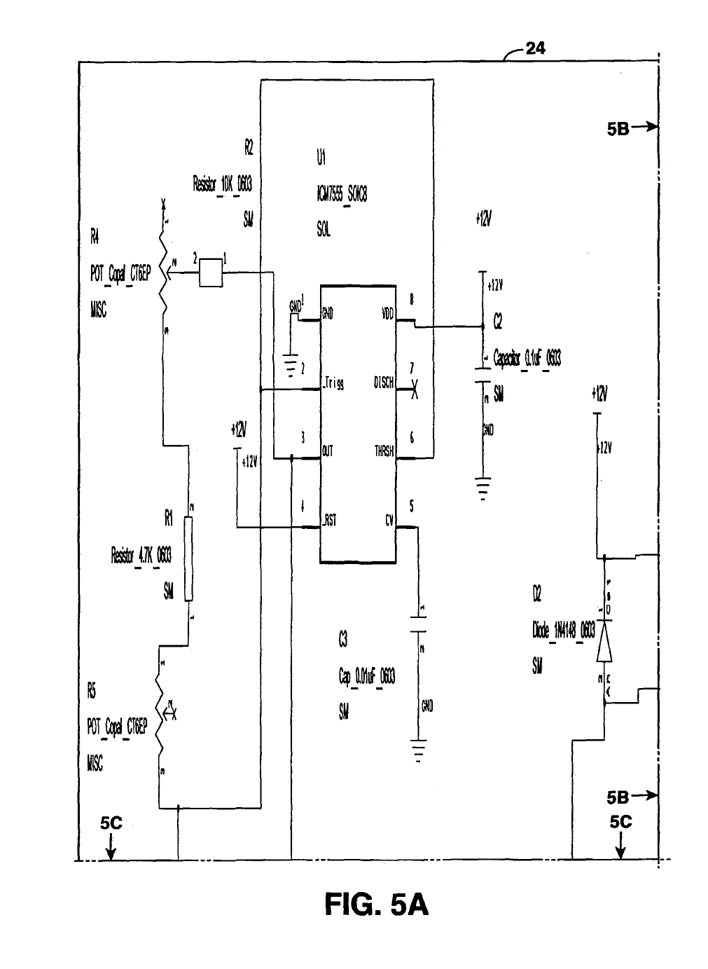

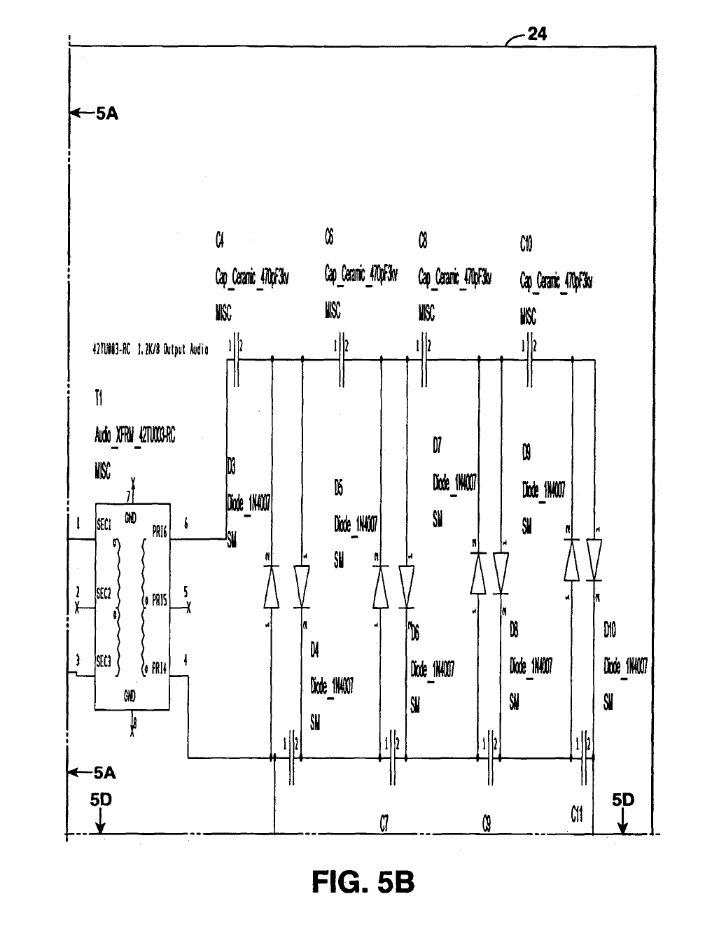

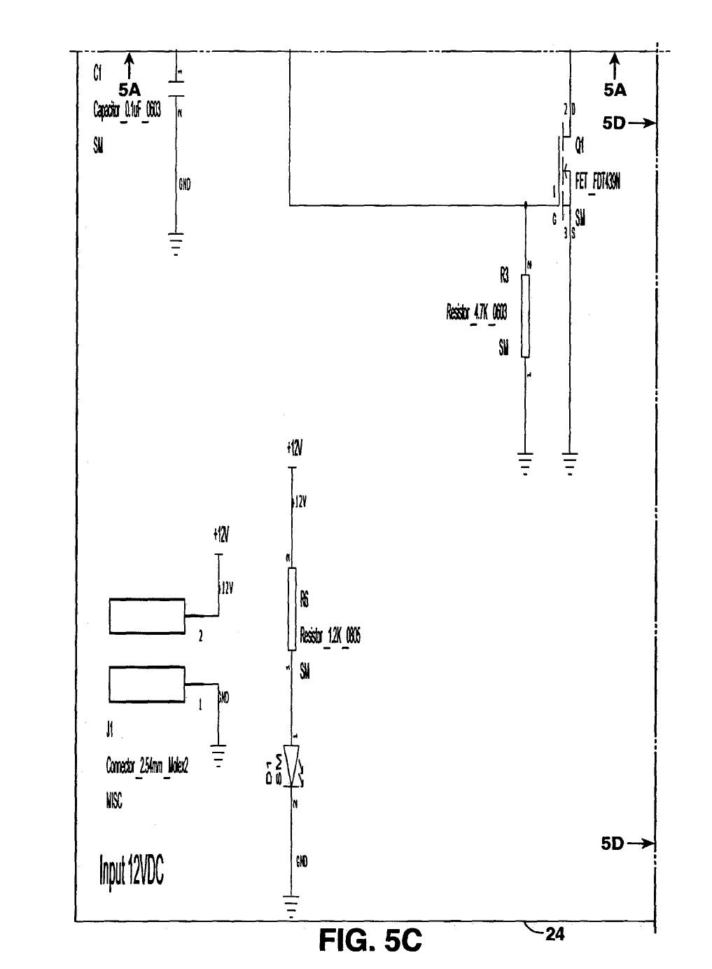

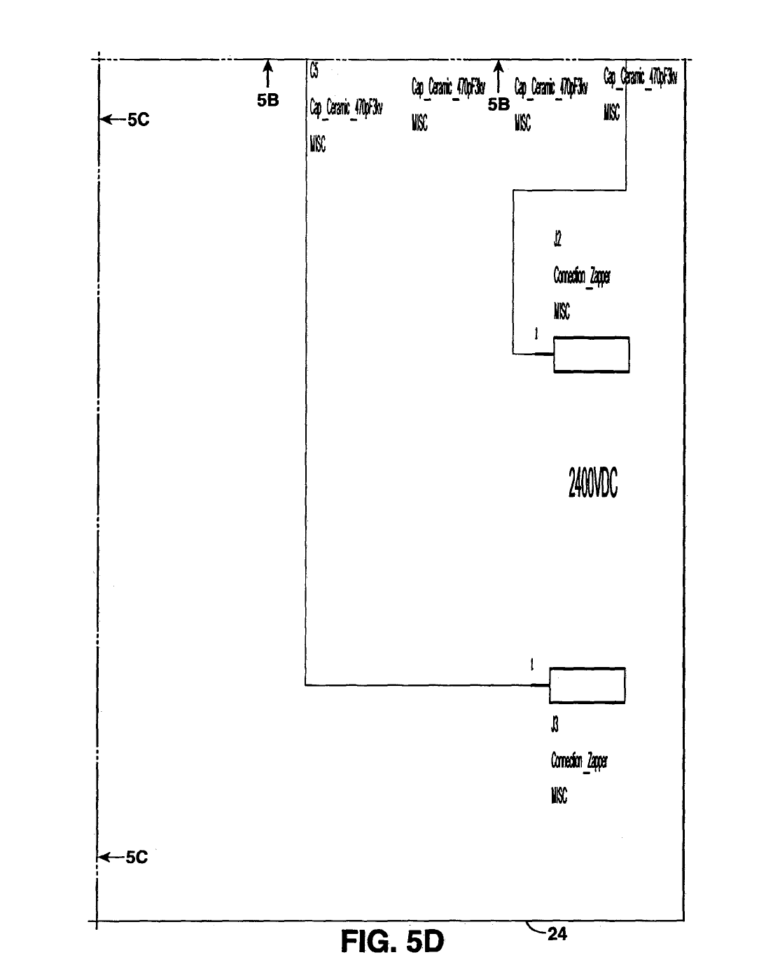

Referring to FIGS. 5 and 5A-5D, in one embodiment, 120 volts AC is dropped to 12 volts DC by a switching circuit. A square wave pulse train is created. The circuit is tunable that the voltage can be adjusted in a range from approximately 200 volts to 2400 volts DC. Using alternating polarity two or more conductors 18 are wired in parallel. The insect 30 is killed by conducting current through its body when it comes in contact with the conductor pairs 18 on the side of the stack with exposed ends of the conductor 18 pairs.

The size and shape of the device 10 and individual units 12 and all its components can be varied by to accommodate different size and shape bed legs 14. The electrical components may be varied or changed to make the device more safe and effective.

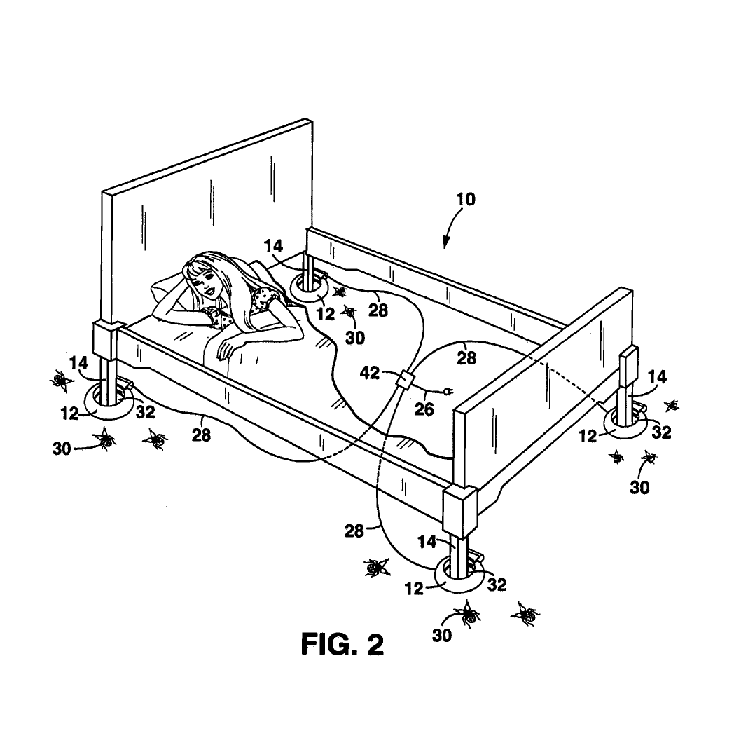

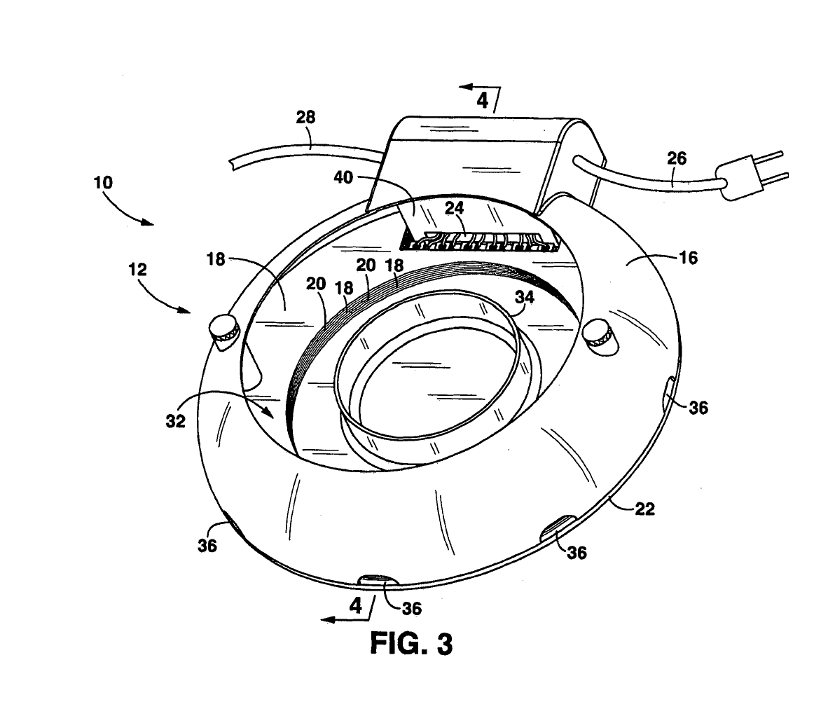

In one embodiment, as shown in FIG. 1, the electronic insect barrier 10 uses four individual units 12 to surround four bed legs 14. Each individual unit 12 is plugged into and powered by a power cord 26 containing a single transformer 42 that plugs into an electrical wall outlet. Further variations of this invention may include four or more individual units 12, each of which has its own batteries for its power source. Additionally, the units 12 may plug into and derive power from a hub transformer 42 by network connection 28, allowing the device 10 to be scalable, as shown in FIG. 2.

The electronic circuit 24 is shielded from contact by the circuit board cover 40. The power on indicator 38 alerts the on looker an electronic insect barrier 10 or individual unit 12 is operational.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. An insect barrier device comprising:
a base;
a housing coupled to the base; and
a stack of a plurality of planer conductors located within the barrier device between the base and the housing, wherein the housing and the each of the plurality of planer conductors have an inner hole therein aligned for a leg of an item of furniture to pass there through onto the base.

2. The device of claim 1, wherein the planer conductors are essentially horizontal when in use.

3. The device of claim 1, wherein the housing creates at least one hole between the housing and the base for insects to enter the device.

4. The device of claim 3, wherein the planer conductors are located within the device such that insects entering the at least one hole between the housing and the device must walk across at least one side of the stack with exposed ends of the plurality of planer conductors to progress toward the leg of the item of furniture.

5. The device of claim 4, wherein the device comprises a power unit that creates an electrical potential between pairs of conductors.

6. The device of claim 5, wherein the power unit creates sufficient potential for a spark to travel through the bug without the bug having to touch both of a pair of conductors.

7. The device of claim 1, wherein the base comprises a tubular anchor that separates the leg of the item of furniture from the plurality of planer conductors.

8. The device of claim 1, wherein the base and the housing are removable coupled to each other with at least a pair of columns.

9. The device of claim 8, wherein the columns pass through and locate each of the plurality of planer conductors within the housing.

10. The device of claim 9, comprising at least one spacer located between pairs of the planer conductors.

11. An insect barrier system comprising a plurality electrically coupled individual units, each of the plurality of units comprising:
a base;
a housing coupled to the base; and
a stack of a plurality of planer conductors located within the barrier device between the base and the housing, wherein the housing and the each of the plurality of planer conductors have an inner hole therein aligned for a leg of an item of furniture to pass there through onto the base.

12. The system of claim 11, wherein the planer conductors are essentially horizontal when in use.

13. The system of claim 11, wherein the housing creates at least one hole between the housing and the base for insects to enter the device.

14. The system of claim 13, wherein the planer conductors are located within the units such that insects entering the at least one hole between the housing and the units must walk across at least one side of the stack with exposed ends of the plurality of planer conductor to progress toward the leg of the item of furniture.

15. The system of claim 14, wherein the units comprise a power unit that creates an electrical potential between pairs of conductors.

16. The system of claim 15, wherein the power unit creates sufficient potential for a spark to travel through the bug without the bug having to touch both of a pair of conductors.

17. The system of claim 11, wherein the base comprises a tubular anchor that separates the leg of the item of furniture from the plurality of planer conductors.

18. The system of claim 11, wherein the base and the housing are removable coupled to each other with at least a pair of columns

19. The system of claim 18, wherein the columns pass through and locate each of the plurality of planer conductors within the housing.

20. The system of claim 19, comprising at least one spacer located between pairs of the planer conductors.
